(19) United States
(12) Patent Application Publication
(10) Pub. No.: US 2017/0013548 A1
(43) Pub. Date: Jan. 12, 2017

(54) METHOD FOR CELL SELECTION AND CELL RESELECTION IN A TIME DIVISION SYNCHRONOUS CODE DIVISION MULTIPLE ACCESS (TD-SCDMA) SYSTEM

(71) Applicant: SAMSUNG ELECTRONICS CO., LTD., GYEONGGI-DO (KR)

(72) Inventors: Venkata Subba Rao MANNE, Karnataka (IN); Gondesi Venkata Mallikarjuna Sanjeevi REDDY, Karnataka (IN)

(73) Assignee: SAMSUNG ELECTRONICS CO., LTD.

(21) Appl. No.: 15/203,541

(22) Filed: Jul. 6, 2016

(30) Foreign Application Priority Data
Jul. 6, 2015 (IN) 3440/CHE/2015 PS
Jun. 16, 2016 (IN) 3440/CHE/2015 CS

(51) Int. Cl. H04W 48/16; H04W 24/10; H04L 5/00; H04W 56/00

(52) U.S. Cl. CPC H04W 48/16; H04W 56/001; H04W 24/10; H04L 5/006; H04W 88/02

(57) ABSTRACT

A method for providing cell selection in time division synchronous code division multiple access (TD-SCDMA) systems is provided. The method includes generating, by a user equipment (UE), an ordered list of universal absolute radio frequency channel numbers (UARFCNs) based on received signal strength indicator (RSSI) measurements associated with one or more UARFCNs, calculating synchronization downlink (SyncDL) correlation energies associated with the UARFCNS, arranging the one or more UARFCNs based on the RSSI and the associated SyncDL correlation energies, scanning the one or more UARFCNs to detect if one or more serving cells are available to be camped on and selecting a serving cell based on a signal to noise ratio (SNR) threshold associated with the UARFCN.

### PRIORITY

This application claims priority under 35 U.S.C. §119(a) to Indian Provisional Patent Application Serial No. 3440/CHE/2015 (PS), which was filed on Jul. 6, 2015, in the Indian Intellectual Property Office, and to Indian Complete Patent Application Serial No. 3440/CHE/2015 (CS), which was filed on Jun. 16, 2016 in the Indian Intellectual Property Office, the entire disclosure of each of which is incorporated herein by reference.

### BACKGROUND

1. Field of the Disclosure

The present disclosure generally relates to communication systems, and more particularly, to a method for performing reselection of a cell to camp on in a wireless communication system.

2. Description of the Related Art

In a global system for mobile communications (GSM) system, after selecting a public land mobile network identity (PLMN), a user equipment (UE) may perform a cell selection procedure and a cell reselection procedure in order to use related network services. The cell selection procedure allows the UE to quickly camp on a serving cell, thereby receiving system information from the PLMN, establishing radio resource control (RRC) links, accessing the network via control channels, and receiving and replying to paging messages. The cell reselection procedure allows the UE to camp on another target cell having better signal quality than the current serving cell. The cell selection procedure and the cell reselection procedure herein may only be performed on suitable or acceptable cells. The “suitable” cell is a cell from which the UE may receive service, and which satisfies a set of suitability criteria that a cell must meet in order to be a “suitable cell”, as per the defined GSM standards.

Currently, as part of the GSM standard, a mobile communication device performing the cell selection must camp on the best available cell in the vicinity. To satisfy this requirement, the mobile communication device typically performs an initial power scan over the selected frequency band to measure the signal strength of the cells in the area and generates a list of candidate cells in decreasing order of the measured received signal strengths for the cells. The mobile communication device then goes through an ordered list of cells, selecting each cell in order to find the first cell in the ordered list that meets the set of suitability criteria. When a suitable cell is found, the mobile communication device performs registration with the cell, if necessary. The mobile communication device then camps on the cell to communicate with a mobile network to which the mobile communication device is subscribed.

However, in a conventional time division synchronous code division multiple access (TD-SCMDA) communication system, where the frame boundary of cells are time aligned, it is possible to have high interference on timeslot-0 (TS-0) where broadcast channels (beacon channels) are transmitted. In the interference conditions, if cell selection is performed just based on conventional received signal strength indication (RSSI) and received signal code power (RSCP) measurements, it is possible to encounter a failure attempting to read the broadcast channel (BCH) and causing cell selection failure, which may cause a delay in cell selection. Further, the BCH read failure on the selected cell may cause a delay in a cell camp on procedure. Moreover, the user experience may be degraded during cell search after OOS (out of service) while a circuit switched/packet switched (CS/PS) call is in progress and may cause the call to drop.

In view of the foregoing, there is a need of an efficient cell selection and cell reselection procedure and sequence of the search operations which will make cell searching optimal and reliable.

### SUMMARY

According to an aspect of the present disclosure, a method and apparatus for providing cell selection in TD-SCDMA systems is provided. The method includes generating, by a UE, an ordered list of universal absolute radio frequency channel numbers (UARFCNs) based on received signal strength indicator (RSSI) measurements associated with one or more UARFCNs, calculating synchronization downlink (SyncDL) correlation energies associated with the UARFCNS, arranging the one or more UARFCNs based on the RSSI and the associated SyncDL correlation energies, scanning the one or more UARFCNs to detect if one or more serving cells are available to be camped on and selecting a serving cell based on a Signal to noise ratio (SNR) threshold associated with the UARFCN.

According to an aspect of the present disclosure, a method is provided for TD-SCDMA systems, the method comprises selecting a plurality of UARFCNs from a database based on previously camped cell information, detecting an RSSI measurement and SyncDL correlation energies associated with the RSSI, arranging the plurality of UARFCNs into a first list and a second list based on a location area update (LAU) information, scanning the plurality of UARFCNs to detect if one or more cells are available from the first list and the second list and selecting a serving cell present in the UARFCN based on an SNR threshold associated with the serving cell.

### BRIEF DESCRIPTION OF THE DRAWINGS

The above and other aspects, features and advantages of the present disclosure will be more apparent to those skilled in the art from the following description taken in conjunction with the accompanying drawings in which:

FIG. 1 is a flowchart illustrating a method of enabling cell reselection in a TD-SCDMA system, according to an embodiment of the present disclosure;

FIG. 2 is a flowchart illustrating a method of enabling cell reselection in a TD-SCDMA system, according to another embodiment of the present disclosure;

FIG. 3 is a flowchart illustrating a method of TD-SCDMA UARFCNs cell selection based on the best SYNC-DL correlation energy, according to an embodiment of the present disclosure; and

FIG. 4 is a flowchart illustrating a method of enabling a suitable serving cell selection from a set of shortlisted UARFCNs, according to an embodiment of the present disclosure.

### DETAILED DESCRIPTION

The present disclosure provides a method and apparatus for providing cell selection in TD-SCDMA systems. In the following detailed description of the embodiments of the disclosure, reference is made to the accompanying drawings that form a part thereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following detailed description is, therefore, not to be taken in a limiting sense, and the scope of the present disclosure is defined by the appended claim and their equivalents.

Although specific features of the present disclosure are shown in some drawings and not in others, this is done for convenience only as each feature may be combined with any, or all, of the other features in accordance with an embodiment of the present disclosure.

The present disclosure may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “includes”, “comprises”, “including” and/or “comprising” when used in this specification, specify the presence of stated features, integers, steps, operations, elements and/or components, but do not preclude the presence or addition of one or more other features, integers, steps, operations, elements, components, and/or groups thereof. As used herein, the term “and/or” includes any and all combinations and arrangements of one or more of the associated listed items.

Unless otherwise defined, all terms (including technical and scientific terms) used herein have the same meaning as commonly understood by one of ordinary skill in the art to which this disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present disclosure provides a system and method for providing cell selection in TD-SCDMA systems. Various embodiments of the present disclosure describe the method, but do not limit the scope of the present disclosure.

The embodiments herein and the various features and advantages thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of ordinary skill in the art to practice the embodiments herein. Accordingly, the examples should not be construed as limiting the scope of the embodiments herein.

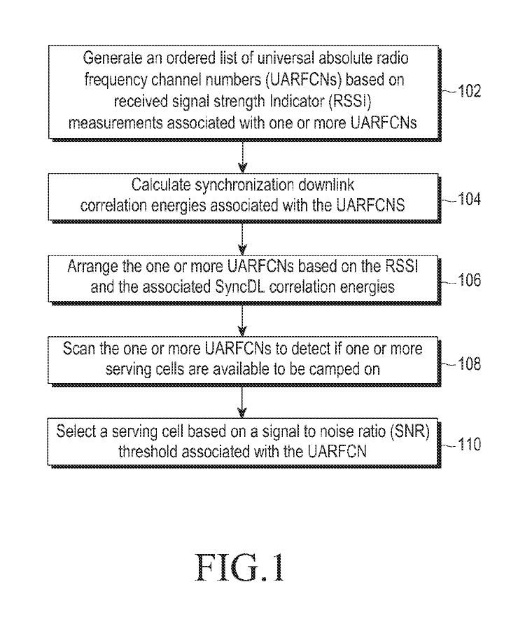

FIG. 1 is a flowchart illustrating a method of enabling cell reselection in a TD-SCDMA system, according to an embodiment of the present disclosure.

Referring to flowchart 100 of FIG. 1, at step 102, a UE generates an ordered list of UARFCNs based on a RSSI measurements associated with one or more UARFCNs. At step 104, the UE calculates SyncDL correlation energies associated with the UARFCNS. At step 106, the one or more UARFCNs are arranged based on the RSSI and the associated SyncDL correlation energies. At step 108, the one or more UARFCNs are then scanned to detect if one or more serving cells are available to be camped on. If serving cells are available, then at step 110, a serving cell is selected based on an SNR threshold associated with the UARFCN to be camped on.

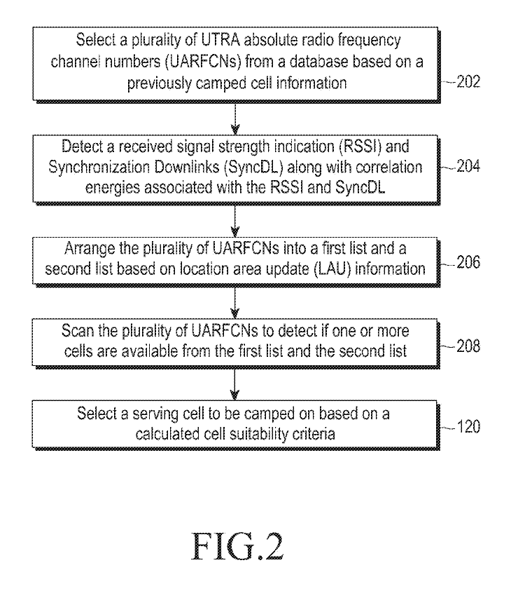

FIG. 2 is a flowchart illustrating a method of enabling cell reselection in a TD-SCDMA system, according to another embodiment of the present disclosure.

Referring to FIG. 2, at step 202, a UE selects a plurality of UARFCNs from a database based on previously camped cell information. At step 204, an RSSI and SyncDL are detected along with correlation energies associated with the RSSI and SyncDL. At step 206, the plurality of UARFCNs are arranged into a first list and a second list based on LAU information. At step 208, the plurality of UARFCNs are scanned to detect if one or more cells are available from the first list and the second list. At step 210, a serving cell to be camped on is selected based on calculated cell suitability criteria.

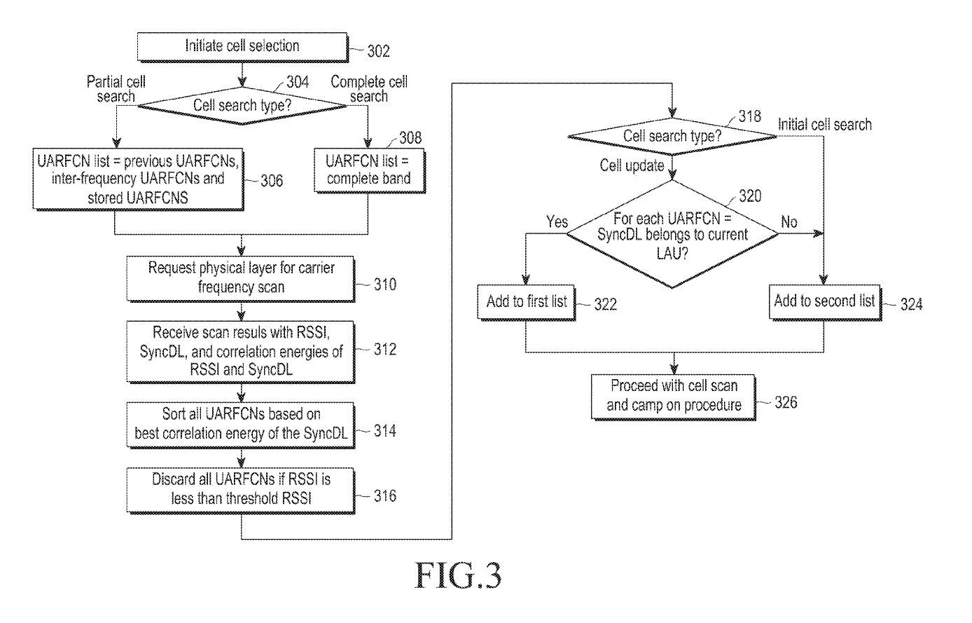

FIG. 3 is a flowchart illustrating a method of TD-SCDMA UARFCNs cell selection based on the best SYNC-DL correlation energy, according to an embodiment of the present disclosure.

Referring to FIG. 3, at step 302, the cell selection process is initiated by a UE. At step 304, the UE determines whether a partial cell search has to be conducted or a complete cell search has to be conducted. If the UE performs a partial search, then at step 306, a UARFCN list may pre-generated, wherein the UARFCN list comprises one or more previous UARFCNs, inter frequency UARFCNs and stored UARFCNs from a database. If the UE performs a complete search, then at step 308, a UARFCN list may pre-generated, wherein the UARFCN list comprises UARFCNs present in the complete frequency band.

The UARFCN list generated from a partial cell search process at step 306 or from a complete cell search process at step 308, may be processed further at step 310, wherein a request is sent to the physical layer of the UE for performing carrier frequency scan. Based on the received request, at step 312, the physical layer provides scan results, wherein the scan results received by the UE comprise RSSI, SyncDL, and correlation energies of the RSSI and SyncDL. Based on the received information from the physical layer, at step 314, the UE sorts all the UARFCNs based on the best correlation energies of the SyncDL.

At step 316, the UE determines whether the RSSI of the UARFCNs is greater than a threshold RSSI. Based on the determination, the UE discards all the UARFCNs whose RSSI is less than a threshold RSSI. At step 318, the UE determines whether a cell update search is to be performed or an initial cell search is to be performed. If a cell update search is to be performed, then at step 320, the UE determines whether for each UARFCN, the SyncDL belongs to a current LAU. If yes, then at step 322, the UARFCN is added to a first list. If no, then at step 324, the UARFCN is added to a second list. If the UE wishes to perform an initial cell search, then the process directly moves to step 324, wherein the UARFCN is added to the second list. At step 326, the UE proceeds further with cell scanning and camp on procedure.

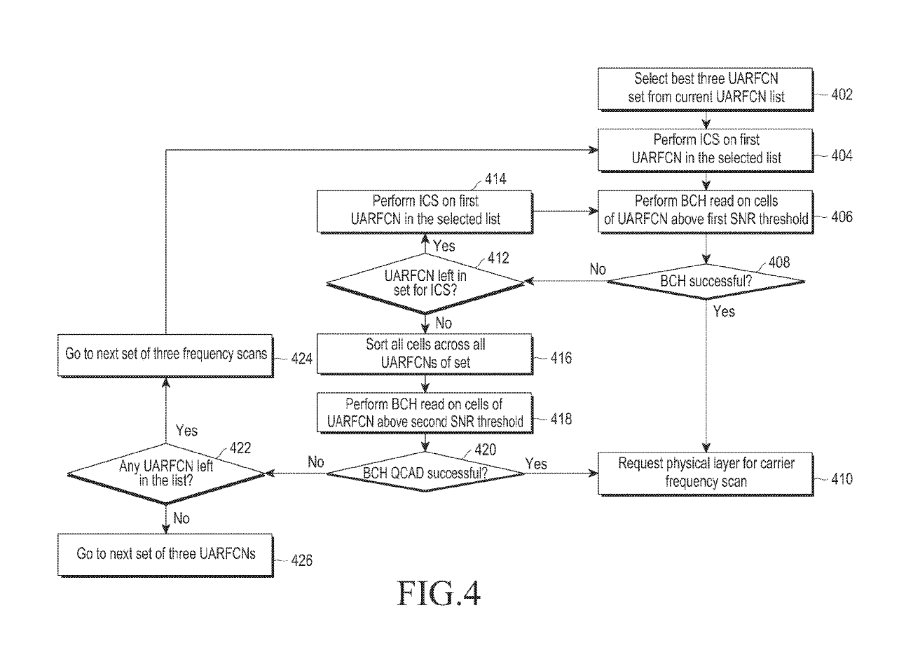

FIG. 4 is a flowchart illustrating a method of enabling a best serving cell selection from a set of shortlisted UARFCNs, according to an embodiment of the present disclosure.

Referring to FIG. 4, at step 402, a UE selects the three best UARFCNs set from a current list of available UARFCNs. At step 404, the UE performs ICS on the first UARFCN selected from the set of three UARFCNs. At step 406, a BCH read is performed on cells with the UARFCN having an SNR value greater than a first threshold SNR. At step 408, the UE determines whether the BCH read is successful or not. If yes, then at step 410, the UE camps on the cell with the selected UARFCN. If no, then at step 412, the UE determines whether there are any UARFCNs left in the set for ICS.

If there are UARFCNs left for ICS, then at step 414, the UE performs ICS on the next UAFCRN in the set. For the selected next UARFCNs in the set, a BCH read may be performed at step 406. If there are no UARFCNs left in the set, then at step 416, all cells across all UARFCNs in the set are sorted. At step 418, a BCH read may be performed on the cells of the selected UARFCNs which have an SNR above a second threshold value.

At step 420, the UE determines whether the BCH read is successful or not. If yes, then at step 410, the UE camps on the cell with the selected UARFCN. If no, then at step 422, the UE further determines whether any UARFCNs are left in the list. If yes, then at step 424, the UE selects the next set of three UARFCNs and proceeds to step 404 for performing ICS. If no, then at step 426, the UE performs a full band search.

While the present disclosure has been shown and described with reference to certain embodiments thereof, it will be understood by those skilled in the art that various changes in form and detail may be made therein without departing from the spirit and scope of the present disclosure as defined by the appended claims and their equivalents.

1-3. (canceled)

4. A method for providing cell selection in time division synchronous code division multiple access (TD-SCDMA) systems, the method comprising:
selecting a plurality of universal absolute radio frequency channel numbers (UARFCNs) from a database based on a previously camped cell information;
determining a received signal strength indication (RSSI) and synchronization downlink (SyncDL) correlation energies associated with the RSSI;
arranging the plurality of UARFCNs into a first list and a second list based on a location area update (LAU) information;
scanning the plurality of UARFCNs to detect if one or more cells are available from the first list and the second list; and
selecting a serving cell based on a signal to noise ratio (SNR) threshold associated with the serving cell.

5. The method of claim 4, wherein selecting a serving cell comprises:
selecting a cell set comprising at least three UARFCNs having a high signal frequency from the plurality of UARFCNs;
performing an Internet protocol multimedia subsystem (IMS) centralized service (ICS) on the first UARFCN in the cell set;
performing a broadcast channel (BCH) read on cells of the first UARFCN which have an SNR greater than a first SNR threshold; and
camping on the serving cell of the first UARFCN if the BCH read is successful.

6. The method of claim 4, further comprising:
determining if the ICS is pending for any UARFCN in the cell set if the BCH read is not successful;
performing the ICS on the UARFCN if the UARFCN is pending in the set; and
performing the BCH read on the serving cells of the UARFCN which have an SNR greater than the first SNR threshold.

7. The method of claim 4, further comprising:
sorting the plurality of serving cells across one or more UARFCNs of the set if no UARFCNs are pending in the set for ICS;
performing the BCH read on one or more serving cells having a carrier frequency with an SNR above a second SNR threshold; and
identifying the serving cell for camping on if the BCH read is successful.

8. The method of claim 4, further comprising:
determining if any UARFCN is pending in the first and second list, if the BCH read is not successful;
selecting a next set of three UARFCNs for identifying the camp on cell if any UARFCN is pending in the first and second list; and
performing a full band frequency search if no UARFCNs are left in the first and second list.

9. The method of claim 4, wherein the database comprises previous used UARFCNs, inter-frequency UARFCNs, and stored UARFCNs.

10. The method of claim 4, wherein arranging the plurality of UARFCNs into a first list and a second list is further based on a location area update (LAU) information.

11. A user equipment (UE) comprising:
a processor configured to:
generate an ordered list of universal absolute radio frequency channel numbers (UARFCNs) based on received signal strength indicator (RSSI) measurements associated with one or more UARFCNs;
calculate synchronization downlink (SyncDL) correlation energies associated with the UARFCNs;
arrange the one or more UARFCNs based on the RSSI measurements and the associated SyncDL correlation energies;
scan the one or more UARFCNs to detect if one or more serving cells are available to be camped on; and
select a serving cell based on a signal to noise ratio (SNR) threshold associated with the UARFCN.

12. The UE of claim 11, wherein scanning the one or more UARFCNs comprises performing an RSSI measurement on each UARFCN in the ordered list to determine whether each RSSI measurement is greater than a predetermined threshold.

13. The UE of claim 11, wherein the processor is further configured to perform a carrier frequency search to generate the ordered list of UARFCNs and calculate the SyncDL correlation energies

14. A user equipment (UE) comprising a processor configured to:
select a plurality of universal absolute radio frequency channel numbers (UARFCNs) from a database based on a previously camped cell information;
determine a received signal strength indication (RSSI) and synchronization downlink (SyncDL) correlation energies associated with the RSSI;
arrange the plurality of UARFCNs into a first list and a second list based on a location area update (LAU) information;
scan the plurality of UARFCNs to detect if one or more cells are available from the first list and the second list; and
select a serving cell based on a signal to noise ratio (SNR) threshold associated with the serving cell.

15. The UE of claim 14, wherein selecting a serving cell comprises:
selecting a cell set comprising at least three UARFCNs having a high signal frequency from the plurality of UARFCNs;
performing an IMS centralized service (ICS) on the first UARFCN in the cell set;
performing a broadcast channel (BCH) read on cells of the first UARFCN which have an SNR greater than a first SNR threshold; and
camping on the serving cell of the first UARFCN if the BCH read is successful.

16. The UE of claim 14, wherein the processor is further configured to:
determine if the ICS is pending for any UARFCN in the cell set if the BCH read is not successful;
perform the ICS on the UARFCN if the UARFCN is pending in the set; and
perform the BCH read on the serving cells of the UARFCN which have an SNR greater than the first SNR threshold.

17. The UE of claim 14, wherein the processor is further configured to:
sort the plurality of serving cells across one or more UARFCNs of the set if no UARFCNs are pending in the set for ICS;
perform the BCH read on one or more serving cells having a carrier frequency with an SNR above a second SNR threshold; and
identify the serving cell for camping on if the BCH read is successful.

18. The UE of claim 14, wherein the processor is further configured to:
determine if any UARFCN is pending in the first and second list, if the BCH read is not successful;
select a next set of three UARFCNS for identifying the camp on cell if any UARFCN is pending in the first and second list; and
perform a full band frequency search if no UARFCNs are left in the first and second list.

19. The UE of claim 14, wherein the database comprises previous used UARFCNs, inter-frequency UARFCNs, and stored UARFCNs.

20. The UE of claim 14, wherein arranging the plurality of UARFCNs into a first list and a second list is further based on a location area update (LAU) information.
